(19) United States
(12) Patent Application Publication
(10) Pub. No.: US 2019/0095025 A1
(43) Pub. Date: Mar. 28, 2019

(54) FORCE TOUCH SENSOR AND MANUFACTURING METHOD THEREOF

(71) Applicant: DONGWOO FINE-CHEM CO., LTD., Jeollabuk-do (KR)

(72) Inventors: Dong Ki Keum, Daejeon (KR); Ji Yeon Kim, Gyeonggi-do (KR); Gwang Yong Tak, Gyeonggi-do (KR)

(21) Appl. No.: 16/136,715

(22) Filed: Sep. 20, 2018

(30) Foreign Application Priority Data
Sep. 28, 2017 (KR) 10-2017-0125767

(51) Int. Cl. G06F 3/041; G02B 5/30

(52) U.S. Cl. CPC G06F 3/0414; G06F 2203/04103; G02B 5/3033; G06F 3/0412

(57) ABSTRACT

The present invention relates to a force touch sensor and a manufacturing method thereof.

The force touch sensor according to the present invention includes a lower electrode layer bonded to a display, an upper electrode layer bonded to a polarizing plate, and a transparent dielectric layer bonded to the lower electrode layer and the upper electrode layer.

According to the present invention, thin film characteristics and flexible characteristics may be improved, manufacturing costs and manufacturing time may be reduced, and manufacturing processes may be simplified and product yield may be improved by simplifying functional layers constituting the force touch sensor.

### CROSS-REFERENCE TO RELATED PATENT APPLICATION

This U.S. non-provisional patent application claims priority under 35 U.S.C. § 119 of Korean Patent Application No. 10-2017-0125767 filed on Sep. 28, 2017 in the Korean Patent Office, the entire contents of which are hereby incorporated by reference.

### BACKGROUND

### 1. Technical Field

The present invention relates to a force touch sensor and a manufacturing method thereof. More particularly, the present invention relates to a force touch sensor in which thin film characteristics and flexible characteristics may be improved, manufacturing costs and manufacturing time may be reduced, and manufacturing processes may be simultaneously simplified and product yield may be improved by simplifying functional layers constituting the force touch sensor, and a manufacturing method thereof.

### 2. Description of the Related Art

Various types of input devices are used to operate computing systems. For example, input devices such as buttons, keys, joysticks, and touch screens are used. Further, since touch sensors are easy and simple to operate, the use of the touch sensors is increasing in operating computing systems.

With the touch sensor, a touch surface of a touch input device including a touch sensor panel, which may be a transparent panel having a touch-sensitive surface, may be configured. Such a touch sensor panel is attached to a front surface of a display screen so that the touch-sensitive surface may cover a visible surface of the display screen. By simply touching a touch screen with a finger or the like, a user may operate a computing system. Generally, the computing system recognizes the touch and a touched position on the touch screen and interprets the touch, thereby performing calculations.

However, according to the related art, a touch sensor only senses coordinates of a touch input by a user and may not sense a magnitude of a force applied by the user, or a separate force sensor to sense the force applied by the user is required, which raises a problem in which a unit price of a product is increased.

To resolve the above-described problem, a force touch sensor capable of simultaneously sensing touch coordinates and touch forces has been introduced.

FIG. 1 is a diagram illustrating a conventional force touch sensor.

Referring to FIG. 1, a conventional force touch sensor 400 includes an upper base film 410, an upper electrode layer 420, a dielectric layer 430, a lower electrode layer 440, and a lower base film 450 and senses not only a touched position but also a magnitude of a touch force.

Such an operation principle will be described below.

When there is no user's touch input, the dielectric layer 430 positioned between the upper electrode layer 420 and the lower electrode layer 440 has a thickness d1.

On the other hand, when the user touches a specific point on the upper electrode layer 420, the thickness of the dielectric layer 430 is reduced to d2 due to a pressure of the touch by the user.

The conventional force touch sensor senses not only a touched position input by the user but also the magnitude of the touch force by sensing such a change in thickness of the dielectric layer 430 and a change in capacitance corresponding to the change in thickness, and this may be expressed as the following Equation 1.

$$Δ C = ɛ \frac{s}{Δ d} \qquad [ Equation 1 ]$$

In Equation 1, ΔC is a changed value in capacitance at a touched point, c is a dielectric constant of the dielectric layer 430, S is an area of a region of the upper and lower electrode layers 420 and 440 corresponding to the touched point, and Δd is a changed value of a thickness of the dielectric layer 430.

Further, according to a structure of the conventional force touch sensor, the upper electrode layer 420 is bonded to a polarizing plate 200 through an adhesive 460 in a state of being formed on the upper base film 410, and the lower electrode layer 440 is bonded to a display 100 through an adhesive 470 in a state of being formed on the lower base film 450.

As described above, the conventional force touch sensor 400 has a structure including the upper base film 410 and the lower base film 450, and thus, has a limitation in thickness reduction and a problem in which the flexible characteristics are deteriorated.

Also, due to the upper base film 410 and the lower base film 450, manufacturing costs and manufacturing time may be increased, manufacturing processes may be complicated, and yield may be decreased.

(Prior-Art Documents)

### PATENT DOCUMENTS

Korean Patent Application Publication No. 10-2015-0117120 (Publication Date: Oct. 19, 2015, Title: Touch Input Apparatus and Electronic Device Having Same)

### SUMMARY

### 1. Technical Problem

A technical objective of the present invention is to improve thin film characteristics and flexible characteristics by simplifying functional layers constituting a force touch sensor.

Another technical objective of the present invention is to reduce manufacturing costs and manufacturing time, and to simplify manufacturing processes and improve product yield by omitting an upper base film and a lower base film.

### 2. Solution to Problem

A force touch sensor according to the present invention includes: a lower electrode layer bonded to a display; an upper electrode layer bonded to a polarizing plate; and a transparent dielectric layer bonded to the lower electrode layer and the upper electrode.

In the force touch sensor according to the present invention, the lower electrode layer and the upper electrode layer may be directly bonded to the display and the polarizing plate, respectively, without using a base film.

In the force touch sensor according to the present invention, the transparent dielectric layer may be an optically clear adhesive (OCA) or an optically clear resin (OCR).

In the force touch sensor according to the present invention, the lower electrode layer may have a triple-layer structure including IZO/APC/IZO.

In the force touch sensor according to the present invention, the lower electrode layer may have a thickness of 600 to 1000 \acute{Å}.

In the force touch sensor according to the present invention, the lower electrode layer may have a surface resistance of 0.5 to 10 Ω/sq.

In the force touch sensor according to the present invention, the transparent dielectric layer may have a modulus of 0.10 to 5 MPa.

In the force touch sensor according to the present invention, the transparent dielectric layer may have a thickness recovery force of 90 to 100%/sec.

In the force touch sensor according to the present invention, the transparent dielectric layer may have a modulus of 0.10 to 5 MPa in a temperature range of −40 to +80° C.

In the force touch sensor according to the present invention, the transparent dielectric layer may have a thickness recovery force of 90 to 100%/sec in a temperature range of −40 to +80° C.

In the force touch sensor according to the present invention, the transparent dielectric layer may have a thickness of 10 to 150 μM.

A method of manufacturing a force touch sensor according to the present invention includes: an operation of transferring a lower electrode layer, in which the lower electrode layer is transferred to a display; an operation of transferring an upper electrode layer, in which the upper electrode layer is transferred to a polarizing plate; and an operation of bonding a transparent dielectric layer, in which the transparent dielectric layer is bonded to the lower electrode layer and the upper electrode layer.

In the method of manufacturing a force touch sensor according to the present invention, the operation of transferring the lower electrode layer may include: forming a first separation layer on a first carrier substrate; forming a lower electrode layer on the first separation layer; bonding the lower electrode layer formed on the first separation layer to a display; and peeling and separating the first carrier substrate.

In the method of manufacturing a force touch sensor according to the present invention, the operation of transferring the upper electrode layer may include: forming a second separation layer on a second carrier substrate; forming an upper electrode layer on the second separation layer; bonding the upper electrode layer formed on the second separation layer to a polarizing plate; and peeling and separating the second carrier substrate.

In the method of manufacturing a force touch sensor according to the present invention, the transparent dielectric layer may be an optically clear adhesive (OCA) or an optically clear resin (OCR).

In the method of manufacturing a force touch sensor according to the present invention, the lower electrode layer may have a triple-layer structure including IZO/APC/IZO.

In the method of manufacturing a force touch sensor according to the present invention, the lower electrode layer may have a thickness of 600 to 1000 \acute{Å}.

In the method of manufacturing a force touch sensor according to the present invention, the lower electrode layer may have a surface resistance of 0.5 to 10 Ω/sq.

In the method of manufacturing a force touch sensor according to the present invention, the transparent dielectric layer may have a modulus of 0.10 to 5 MPa.

In the method of manufacturing a force touch sensor according to the present invention, the transparent dielectric layer may have a thickness recovery force of 90 to 100%/sec.

In the method of manufacturing a force touch sensor according to the present invention, the transparent dielectric layer may have a modulus of 0.10 to 5 MPa in a temperature range of −40 to +80° C.

In the method of manufacturing a force touch sensor according to the present invention, the transparent dielectric layer may have a thickness recovery force of 90 to 100%/sec in a temperature range of −40 to +80° C.

In the method of manufacturing a force touch sensor according to the present invention, the transparent dielectric layer may have a thickness of 10 to 150 μm.

According to the present invention, there is an advantageous effect in that functional layers constituting a force touch sensor can be simplified, thereby improving thin film characteristics and flexible characteristics.

In addition, there is an advantageous effect in that manufacturing costs and manufacturing time can be reduced, and manufacturing processes can be simplified and product yield can be improved, by omitting an upper base film and a lower base film.

### BRIEF DESCRIPTION OF DRAWINGS

FIG. 1 is a diagram illustrating a conventional force touch sensor;

FIG. 2 is a diagram illustrating a force touch sensor according to an exemplary embodiment of the present invention;

FIG. 3 is a process flowchart of a method of manufacturing the force touch sensor according to the exemplary embodiment of the present invention;

FIG. 4 is an exemplary process flowchart of an operation of transferring a lower electrode layer in the method of manufacturing the force touch sensor according to the exemplary embodiment of the present invention;

FIGS. 5 to 8 are exemplary process cross-sectional views of the operation of transferring the lower electrode layer in the method of manufacturing the force touch sensor according to the exemplary embodiment of the present invention;

FIG. 9 is an exemplary process flowchart of an operation of transferring an upper electrode layer in the method of manufacturing the force touch sensor according to the exemplary embodiment of the present invention;

FIGS. 10 to 13 are exemplary process cross-sectional views of the operation of transferring the upper electrode layer in the method of manufacturing the force touch sensor according to the exemplary embodiment of the present invention; and

FIG. 14 is an exemplary process cross-sectional view of an operation of bonding a transparent dielectric layer in the method of manufacturing the force touch sensor according to the exemplary embodiment of the present invention.

### DETAILED DESCRIPTION OF EMBODIMENTS

As specific structural or functional descriptions for the embodiments according to the concept of the invention disclosed herein are merely exemplified for purposes of describing the embodiments according to the concept of the invention, the embodiments according to the concept of the invention may be embodied in various forms but are not limited to the embodiments described herein.

While the embodiments of the present invention are susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

While terms such as “first,” or “second,” etc., may be used to describe various components, such components should not be limited to the above terms. The terms are only used to distinguish one element from another. For example, a first element could be termed a second element, and, similarly, a second element could be termed a first element without departing from the scope of the present invention.

When it is described that one component is “connected” or “joined” to another component, it should be understood that the one component may be directly connected or joined to the other component but another component may be present therebetween. Conversely, when an element is referred to as being “directly connected to” or “directly coupled to” another element, there are no intervening elements present. Further, other expressions describing the relationships between elements should be interpreted in the same way (e.g., “between” versus “directly between,” “adjacent” versus “directly adjacent,” etc.).

The terminology provided herein is merely used for the purpose of describing particular embodiments and is not intended to be limiting of exemplary embodiments of the present invention. An expression used in the singular encompasses the expression of the plural, unless it has a clearly different meaning in the context. It should be understood that the terms “comprises,” “comprising,” “includes,” and/or “including” used herein specify the presence of stated features, integers, steps, operations, elements, components, and/or combinations thereof, but do not preclude the presence or addition of one or more other features, integers, steps, operations, elements, components, and/or combinations thereof.

Unless otherwise defined, all terms used herein including technical or scientific terms have the same meanings as those generally understood by one of ordinary skill in the art. It should be further understood that terms, such as those defined in commonly used dictionaries, should be interpreted as having a meaning that is consistent with their meaning in the context of the relevant art and are not to be interpreted in an idealized or overly formal sense unless expressly so defined herein.

Hereinafter, exemplary embodiments of the present invention will be described in detail with reference to the accompanying drawings.

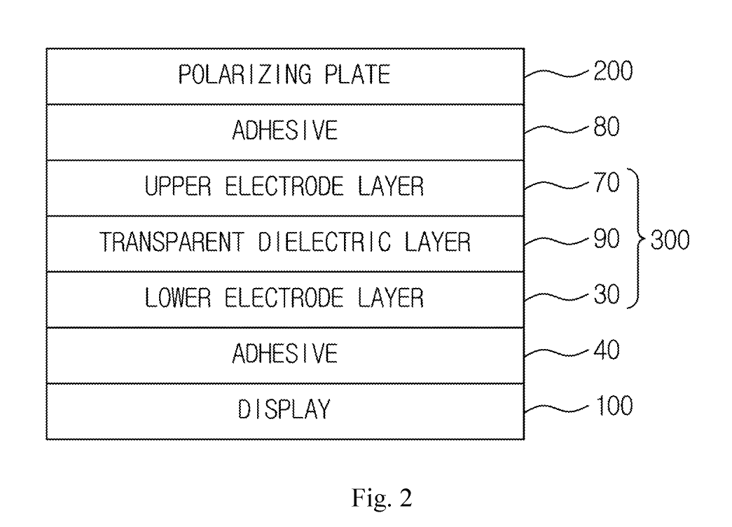

FIG. 2 is a diagram illustrating a force touch sensor according to an exemplary embodiment of the present invention.

Referring to FIG. 2, a force touch sensor 300 according to the exemplary embodiment of the present invention includes a lower electrode layer 30, an upper electrode layer 70, and a transparent dielectric layer 90.

The lower electrode layer 30 is directly bonded to a display 100 through an adhesive 40 and the upper electrode layer 70 is directly bonded to a polarizing plate 200 through an adhesive 80.

Both surfaces of the transparent dielectric layer 90 are directly bonded to the lower electrode layer 30 and the upper electrode layer 70, respectively. As an example, the transparent dielectric layer 90 may be an optically clear adhesive (OCA) or an optically clear resin (OCR), and the lower electrode layer 30 and the upper electrode layer 70 may be configured to be directly bonded to the display 100 and the polarizing plate 200, respectively, without using a base film.

When each of the lower electrode layer 30 and the upper electrode layer 70 is bonded using a material such as the OCA or OCR, which has an adhesive function and a specific dielectric constant, the transparent dielectric layer 90, which is necessary for sensing changes in capacitance, may be simultaneously implemented by merely performing a process of bonding each of the lower electrode layer 30 and the upper electrode layer 70 using the OCA or OCR so that processes for manufacturing the force touch sensor 300 may be simplified and manufacturing costs may be reduced.

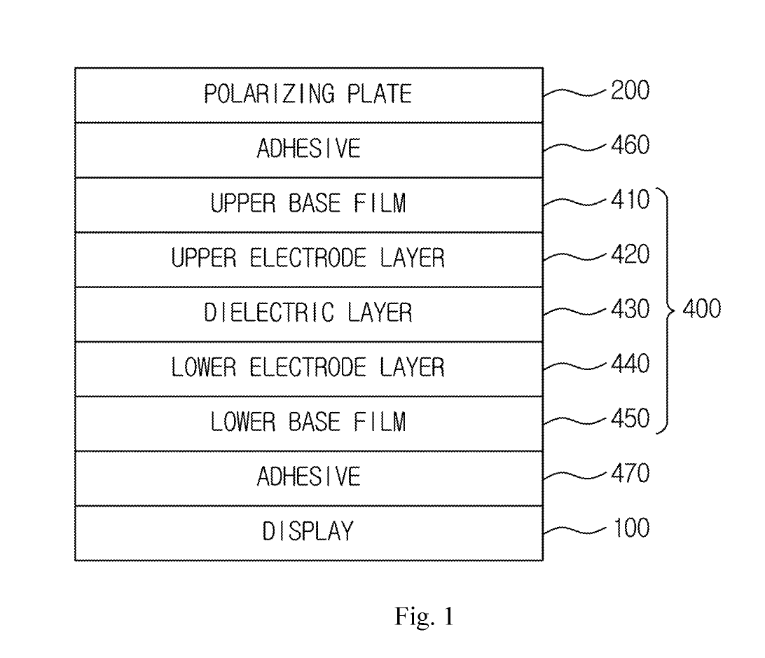

A conventional force touch sensor 400 described with reference to FIG. 1 has a structure in which a polarizing plate 200 and an upper base film 410 are bonded to each other through an adhesive 460 in a state in which an upper electrode layer 420 is formed on the upper base film 410. Similarly, the conventional force touch sensor 400 has a structure in which a display 100 and a lower base film 450 are bonded to each other through an adhesive 470 in a state in which a lower electrode layer 440 is formed on the lower base film 450. As described above, since the conventional force touch sensor 400 has a structure in which the upper base film 410 and the lower base film 450 are essentially included, a thickness of the force touch sensor 400 may be increased due to the base films 410 and 450, so that thin film characteristics and flexible characteristics are deteriorated. Also, as processes using these base films 410 and 450 are added, manufacturing costs and manufacturing time may be increased, a manufacturing process may be complicated, and product yield may be decreased.

On the other hand, the force touch sensor 300 according to the exemplary embodiment of the present invention shown in FIG. 2 has a structure in which the lower electrode layer 30 is directly bonded to the display 100 through the adhesive 40 and the upper electrode layer 70 is also directly bonded to the polarizing plate 200 through the adhesive 80. According to the structure in which the base films 410 and 450 are omitted as described above, functional layers constituting the force touch sensor 300 may be simplified, thereby improving thin film characteristics and flexible characteristics, reducing manufacturing costs and manufacturing time, and simplifying manufacturing processes and improving product yield.

For example, the lower electrode layer 30 may be configured to have a triple-layer structure including IZO/APC/IZO to reduce costs and improve sensitivity.

For example, the lower electrode layer 30 may have a thickness of 600 to 1000 Å, and an optimal thickness of about 840 Å. When the lower electrode layer 30 has a thickness of 600 to 1000 Å, durability and electrical sensitivity of the force touch sensor 300 may be maintained, and, simultaneously, optical characteristics including light transmittance, thin characteristics, and flexible characteristics may be maintained.

For example, in order to secure electrical characteristics including the sensitivity of the force touch sensor 300, the lower electrode layer 30 may be configured to have a surface resistance of 0.5 to 10 Ω/sq.

For example, the transparent dielectric layer 90 may be configured to have a modulus of 0.10 to 5 MPa, and more particularly, a modulus of 0.10 to 5 MPa at a temperature of −40 to +80° C.

Table 1 below shows experimental data of a modulus variation according to the temperature of the transparent dielectric layer 90.

TABLE 1

| Temperature (° C.) | Modulus (Mpa) |
|---|---|
| −40 | 2.34 |
| 0 | 0.30 |
| 25 | 0.19 |
| 60 | 0.14 |
| 80 | 0.13 |
| 100 | 0.11 |

Referring to Table 1, the modulus of the transparent dielectric layer 90 has characteristics inversely proportional to the temperature. Further, when the transparent dielectric layer 90 is configured not to have a modulus of 0.10 to 5 MPa at a temperature of −40 to +80° C., a recovery force of the transparent dielectric layer 90 may be deteriorated, and since the thickness of the force touch sensor 300 is required to be changed to maintain the modulus characteristics, it is difficult to make the force touch sensor 300 thinner and maintain flexible characteristics.

For example, in order to maintain the performance of an electronic device to which the force touch sensor 300 is applied including recognition of the force touch input by the user, the transparent dielectric layer 90 may be configured to have a thickness recovery force of 90 to 100%/sec, and more particularly, 90 to 100%/sec in a temperature range of −40 to +80° C.

For example, the transparent dielectric layer 90 may have a thickness of 10 to 150 um. Such a configuration may sense changed levels in capacitance corresponding to various changed levels in thickness of the transparent dielectric layer 90 and sense the magnitude of the user's touch force using the changed levels in capacitance as an input value. When the transparent dielectric layer 90 has a thickness of less than 10 um, the number of changed levels in capacitance is reduced such that the number of magnitude levels of the touch force of the user is reduced, and when the thickness of the transparent dielectric layer 90 is more than 150 um, time required to recover to the thickness before a touched time point increases and thinning is difficult to achieve, resulting in deterioration of optical characteristics such as light transmittance and flexible characteristics

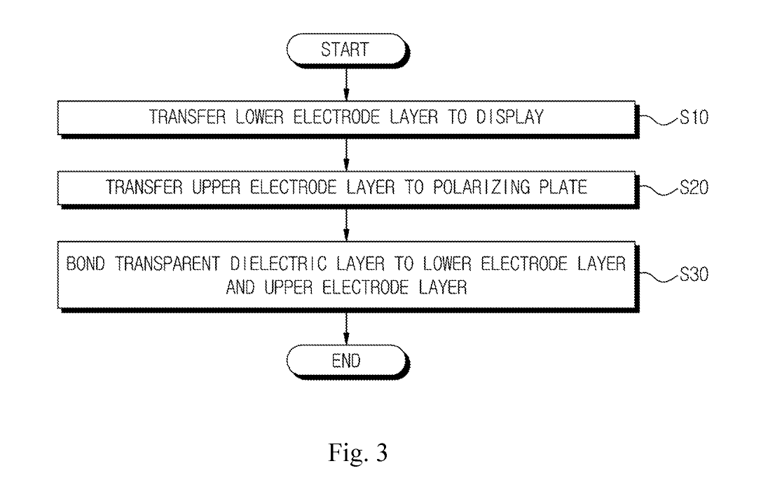

FIG. 3 is a process flowchart of a method of manufacturing the force touch sensor according to the exemplary embodiment of the present invention.

Referring to FIG. 3, the method of manufacturing the force touch sensor according to the exemplary embodiment of the present invention includes operation S10 of transferring a lower electrode layer, operation S20 of transferring an upper electrode layer, and operation S30 of bonding a transparent dielectric layer.

In the method of manufacturing the force touch sensor according to the exemplary embodiment of the present invention, operation S10 of transferring the lower electrode layer and operation S20 of transferring the upper electrode layer may be performed in a different order or simultaneously. Further, physical characteristics of constituent elements of the force touch sensor 300 according to the exemplary embodiment of the present invention described above in detail may be applied as they are to the manufacturing method, and thus in the following description, redundant explanation will be avoided as much as possible.

A process of transferring the lower electrode layer 30 to the display 100 is performed in operation S10 of transferring the lower electrode layer.

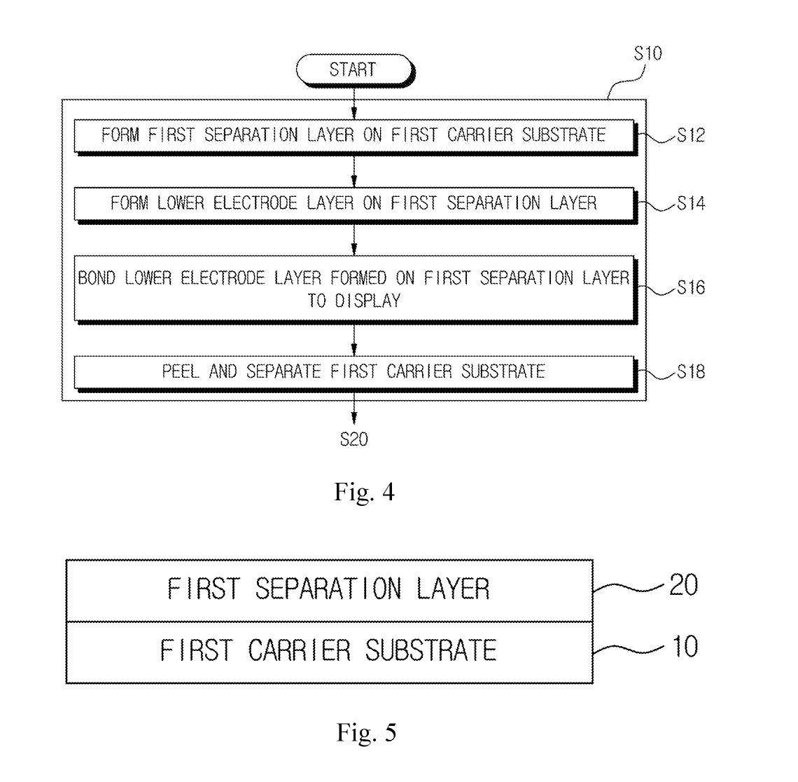

For example, an exemplary configuration of operation S10 of transferring the lower electrode layer will be described below with additional reference to FIGS. 4 to 8 which illustrate an exemplary process flowchart and process cross-sectional views of operation S10 of transferring the lower electrode layer.

Referring to FIGS. 4 and 5 additionally, a process of forming a first separation layer 20 on a first carrier substrate 10 is performed in operation S12.

As an example, a material of the first carrier substrate 10 may be used without any particular limitation as long as the material provides a proper strength to be fixed without being bent or twisted during the process and has little effect on heat or chemical treatment. For example, glass, quartz, a silicon wafer, SUS, or the like may be used.

The first separation layer 20 is a layer formed to peel off the lower electrode layer 30 formed on the first separation layer 20 from the first carrier substrate 10 in a process of manufacturing the force touch sensor 300 according to the exemplary embodiment of the present invention.

For example, the first separation layer 20 and the first carrier substrate 10 may be separated from each other by one of a physical method (light, heat, etc.), a chemical method (chemical reaction), and a mechanical method (force and vibration), or a combination of a plurality of methods.

More particularly, the first separation layer 20 performs a function which adjusts adhesive forces between elements to be separated so that differences between the adhesive forces occur, in a process of separating the first carrier substrate 10 through operation S18 to be described later. For example, a bonding force between the lower electrode layer 30 and the first separation layer 20 may be configured to be greater than a bonding force between the first carrier substrate 10 and the first separation layer 20. Such a configuration may stably peel the first carrier substrate 10 off from the first separation layer 20 without affecting the bonding between the lower electrode layer 30 and the first separation layer 20.

An exemplary material for the first separation layer 20 may be made of a polymer such as a polyimide-based polymer, a poly vinyl alcohol-based polymer, a polyamic acid-based polymer, a polyamide-based polymer, a polyethylene-based polymer, a polystyrene-based polymer, a polynorbornene-based polymer, a phenylmaleimide copolymer-based polymer, a polyazobenzene-based polymer, a polyphenylenephthalamide-based polymer, a polyester-based polymer, a polymethyl methacrylate-based polymer, a polyarylate-based polymer, a cinnamate-based polymer, a coumarin-based polymer, a phthalimidine-based polymer, a chalcone-based polymer, and aromatic acetylene-based polymer, or the like, and they may be used alone or in a combination of two or more.

Although a peeling strength of the first separation layer 20 is not particularly limited, for example, the peeling strength may be 0.01 N/25 mm or more and 1 N/25 mm or less, and may preferably be 0.01 N/25 mm or more and 0.1 N/25 mm or less. When the above-described range is satisfied, in the process of manufacturing the force touch sensor 300, the lower electrode layer 30 or the first separation layer 20 on which the lower electrode layer 30 is formed may be easily peeled off from the first carrier substrate 10 without residue, and curls and cracks caused by tension generated during the peeling operation may be reduced.

Although a thickness of the first separation layer 20 is not particularly limited, for example, the thickness may be in a range of 10 nm to 1,000 nm and may preferably be in a range of 50 nm to 500 nm. When the above-described range is satisfied, the peeling strength is stabilized and uniform patterns may be formed.

Although not shown in the drawing, a first protective layer may be formed on the first separation layer 20.

The first protective layer is an optional element which may be omitted if necessary that prevents the first separation layer 20 from being damaged by being exposed to a process chemical or a developing solution, which is used for forming the lower electrode layer 30, a cleaning liquid which is generated between processes, or the like, during the process of manufacturing the force touch sensor 300.

Polymers known in the art may be used as a material of the first protective layer without limitation. For example, an organic insulating film may be applied, and, among them, those formed of a curable composition including a polyol and a melamine curing agent may be applied, but the present invention is not limited thereto.

Specific examples of the polyol may include a polyether glycol derivative, a polyester glycol derivative, a polycaprolactone glycol derivative, and the like, but the present invention is not limited thereto.

Specific examples of the melamine curing agent may include a methoxy methyl melamine derivative, a methyl melamine derivative, a butyl melamine derivative, an isobutoxy melamine derivative, a butoxy melamine derivative, and the like, but the present invention is not limited thereto.

As another example, the first protective layer may be formed of an organic-inorganic hybrid curable composition, and the use of an organic compound and an inorganic compound at the same time is preferable in that cracks generated during the peeling operation may be reduced.

The above-described components may be used as the organic compound, and examples of the inorganic compound may include silica-based nanoparticles, silicon-based nanoparticles, glass nanofibers, and the like, but the present invention is not limited thereto.

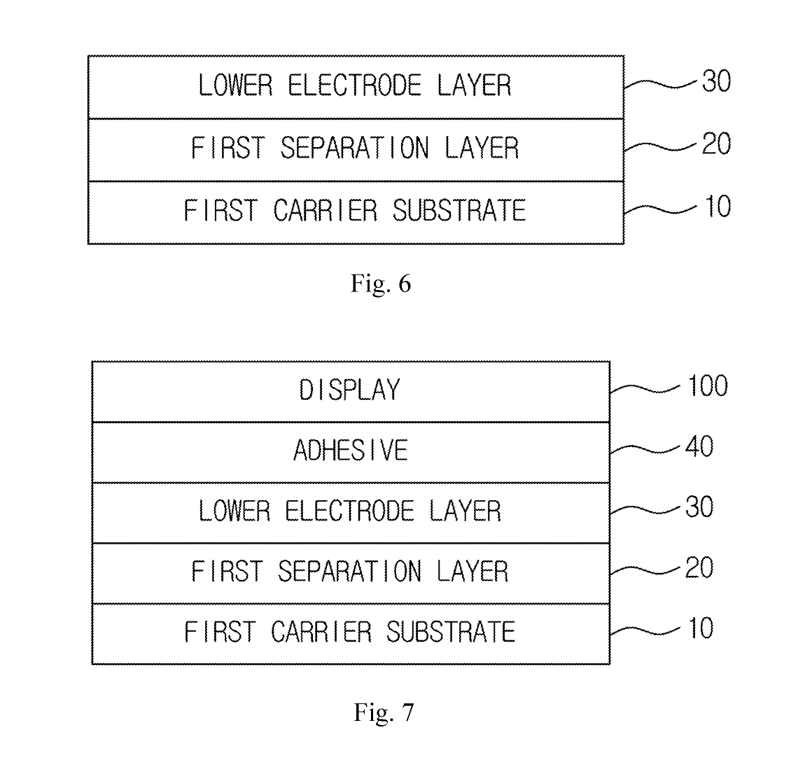

Referring to FIGS. 4 and 6 additionally, a process of forming the lower electrode layer 30 on the first separation layer 20 is performed in operation S14.

As an example, the lower electrode layer 30 may be configured to have a triple-layer structure including IZO/APC/IZO to reduce costs and improve sensitivity.

Referring to FIGS. 4 and 7 additionally, a process of bonding the lower electrode layer 30 formed on the first separation layer 20 to the display 100 through the adhesive 40 is performed in operation S16.

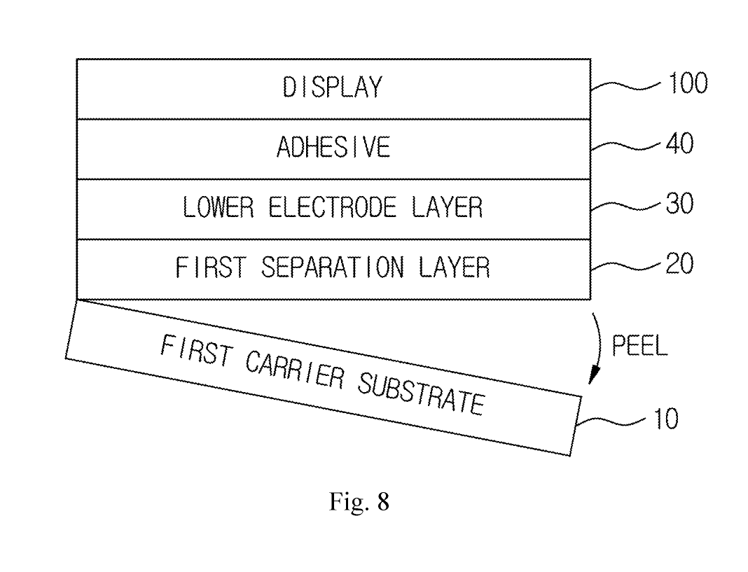

Referring to FIGS. 4 and 8 additionally, a process of peeling and separating the first carrier substrate 10 is performed in operation S18. FIG. 8 shows that the first separation layer 20 remains on the lower electrode layer 30, but this is only one example, and the first separation layer 20 may be peeled off and separated from the lower electrode layer 30 together with the first carrier substrate 10.

A process of transferring the upper electrode layer 70 to the polarizing plate 200 is performed in operation S20 of transferring the upper electrode layer.

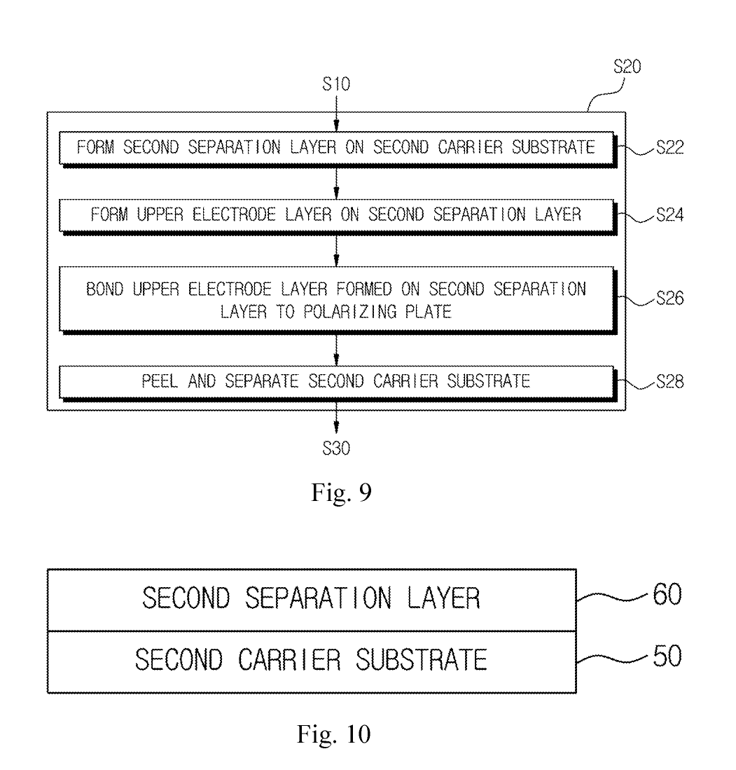

As an example, an exemplary configuration of operation S20 of transferring the upper electrode layer will be described below with reference additionally to FIGS. 9 to 13 which illustrate an exemplary process flowchart and process cross-sectional views of operation S20 of transferring the upper electrode layer.

Since operation S20 of transferring the upper electrode layer is similar to operation S10 of transferring the lower electrode layer described above in detail, descriptions of the first carrier substrate 10, the first separation layer 20, the first protective layer, and the like may be applied directly to a second carrier substrate 50, a second separation layer 60, and a second protective layer.

Referring to FIGS. 9 and 10, a process of forming the second separation layer 60 on the second carrier substrate 50 is performed in operation S22.

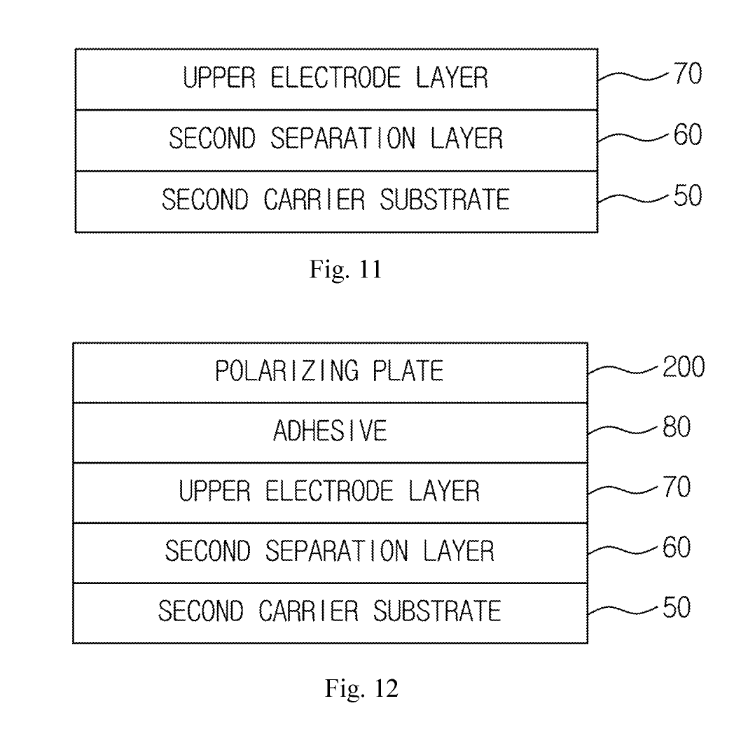

Referring to FIGS. 9 and 11, a process of forming the upper electrode layer 70 on the second separation layer 60 is performed in operation S22.

Referring to FIGS. 9 and 12, a process of bonding the upper electrode layer 70 formed on the second separation layer 60 to the polarizing plate 200 is performed in operation S22.

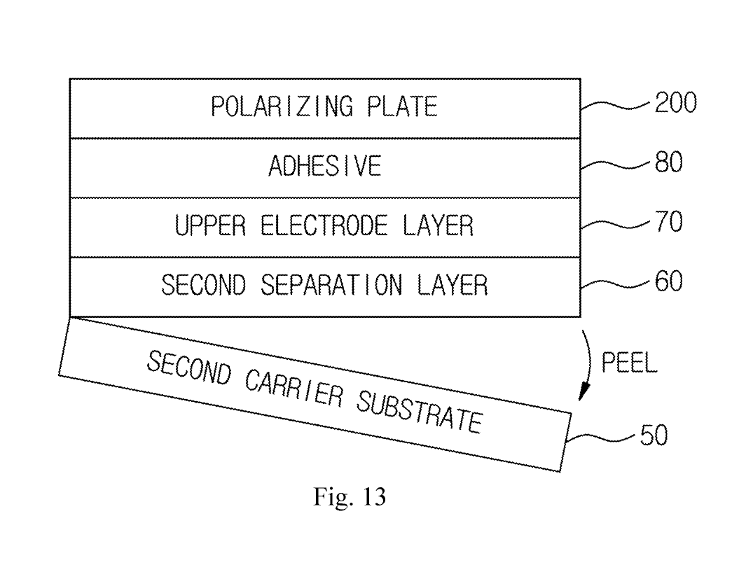

Referring to FIGS. 9 and 13, a process of peeling and separating the second carrier substrate 50 is performed in operation S22.

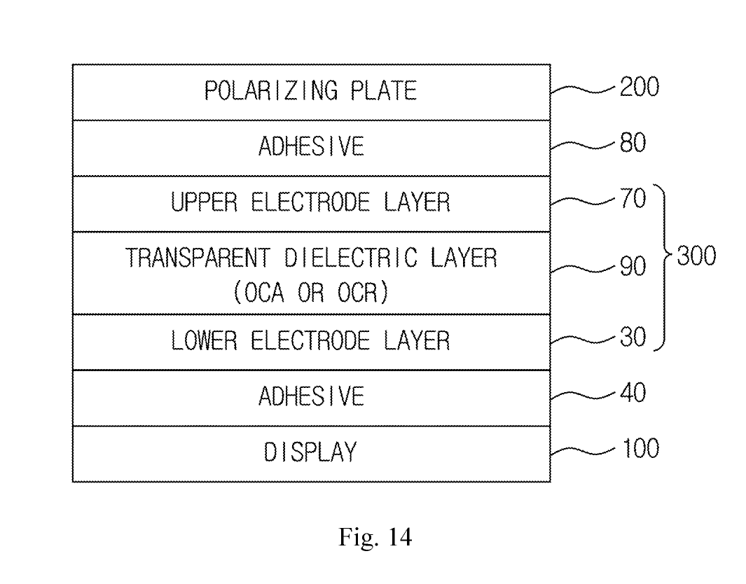

Next, referring to FIG. 14 additionally, a process of bonding both surfaces of the transparent dielectric layer 90 to the lower electrode layer 30 and the upper electrode layer 70, respectively, is performed in operation S30 of bonding the transparent dielectric layer.

When operation S30 of bonding the transparent dielectric layer is performed, the lower electrode layer 30 is directly bonded to the display 100 through the adhesive 40, the upper electrode layer 70 is directly bonded to the polarizing plate 200 through the adhesive 80, and both surfaces of the transparent dielectric layer 90 are directly bonded to the lower electrode layer 30 and the upper electrode layer 70, respectively. As an example, the transparent dielectric layer 90 may be an optically clear adhesive (OCA) or an optically clear resin (OCR), and the lower electrode layer 30 and the upper electrode layer 70 may be configured to be directly bonded to the display 100 and the polarizing plate 200, respectively, without using a base film.

When each of the lower electrode layer 30 and the upper electrode layer 70 is bonded using a material such as the OCA or OCR, which has an adhesive function and a specific dielectric constant, the transparent dielectric layer 90, which is necessary for sensing changes in capacitance, may be simultaneously implemented by merely performing a process of bonding each of the lower electrode layer 30 and the upper electrode layer 70 using the OCA or OCR so that processes for manufacturing the force touch sensor 300 may be simplified and manufacturing costs may be reduced.

What is claimed is:

1. A force touch sensor comprising:
a lower electrode layer bonded to a display;
an upper electrode layer bonded to a polarizing plate; and
a transparent dielectric layer bonded to the lower electrode layer and the upper electrode layer.

2. The force touch sensor of claim 1, wherein the lower electrode layer and the upper electrode layer are directly bonded to the display and the polarizing plate, respectively, without using a base film.

3. The force touch sensor of claim 1, wherein the transparent dielectric layer is an optically clear adhesive (OCA) or an optically clear resin (OCR).

4. The force touch sensor of claim 1, wherein the lower electrode layer has a triple-layer structure including IZO/APC/IZO.

5. The force touch sensor of claim 1, wherein the lower electrode layer has a thickness of 600 to 1000 \acute{Å}.

6. The force touch sensor of claim 1, wherein the lower electrode layer has a surface resistance of 0.5 to 10 Ω/sq.

7. The force touch sensor of claim 1, wherein the transparent dielectric layer has a modulus of 0.10 to 5 MPa.

8. The force touch sensor of claim 1, wherein the transparent dielectric layer has a thickness recovery force of 90 to 100%/sec.

9. The force touch sensor of claim 1, wherein the transparent dielectric layer has a thickness of 10 to 150 μm.

10. A method of manufacturing a force touch sensor, comprising:
an operation of transferring a lower electrode layer, in which the lower electrode layer is transferred to a display;
an operation of transferring an upper electrode layer, in which the upper electrode layer is transferred to a polarizing plate; and
an operation of bonding a transparent dielectric layer, in which the transparent dielectric layer is bonded to the lower electrode layer and the upper electrode layer.

11. The method of claim 10, wherein the operation of transferring the lower electrode layer includes:
forming a first separation layer on a first carrier substrate;
forming a lower electrode layer on the first separation layer;
bonding the lower electrode layer formed on the first separation layer to a display; and
peeling and separating the first carrier substrate.

12. The method of claim 10, wherein the operation of transferring the upper electrode layer includes:
forming a second separation layer on a second carrier substrate;
forming an upper electrode layer on the second separation layer;
bonding the upper electrode layer formed on the second separation layer to a polarizing plate; and
peeling and separating the second carrier substrate.

13. The method of claim 10, wherein the transparent dielectric layer is an optically clear adhesive (OCA) or an optically clear resin (OCR).

14. The method of claim 10, wherein the lower electrode layer has a triple-layer structure including IZO/APC/IZO.

15. The method of claim 10, wherein the lower electrode layer has a thickness of 600 to 1000 \acute{Å}.

16. The method of claim 10, wherein the lower electrode layer has a surface resistance of 0.5 to 10 Ω/sq.

17. The method of claim 10, wherein the transparent dielectric layer has a modulus of 0.10 to 5 MPa.

18. The method of claim 10, wherein the transparent dielectric layer has a thickness recovery force of 90 to 100%/sec.

19. The method of claim 10, wherein the transparent dielectric layer has a thickness of 10 to 150 μm.
